(19) United States
(12) Patent Application Publication
(10) Pub. No.: US 2005/0101708 A1
(43) Pub. Date: May 12, 2005

(54) Flame-retardant thermoset compositions

(75) Inventors: Susanne Knop, Huerth (DE); Martin Sicken, Koeln (DE); Sebastian Hoerold, Diedorf (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/669,921

(22) Filed: Sep. 24, 2003

(30) Foreign Application Priority Data
Sep. 25, 2002 (DE) 102 44 576.1

(51) Int. Cl. C08K 5/49

(52) U.S. Cl. 524/115

(57) ABSTRACT

The invention relates to flame-retardant thermoset compositions which comprise, as flame retardant, at least one phosphinic salt of the formula (I) and/or a diphosphinic salt of the formula (II) and/or polymers of these (component A) 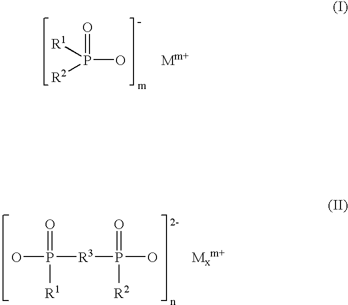 where
R¹,R² are identical or different and are C₁-C₆-alkyl, linear or branched, and/or aryl;
R³ is C₁-C₁₀-alkylene, linear or branched, C₆-C₁₀-arylene, -alkylarylene or -arylalkylene; M is Mg, Ca, Al, Sb, Sn, Ge, Ti, Zn, Fe, Zr, Ce, Bi, Sr, Mn, Li, Na, K and/or a protonated nitrogen base; m is from 1 to 4; n is from 1 to 4; and x is from 1 to 4, and also comprise as component B at least one synthetic inorganic compound and/or a mineral product. The invention further relates to a process for preparing these flame-retardant thermoset compositions.

The invention relates to flame-retardant thermoset compositions, to a process for their preparation, and to their use.

Components made from thermoset resins, in particular those which have glass-fiber reinforcement, feature good mechanical properties, low density, substantial chemical resistance and excellent surface quality. This and their low cost has led to their increasing use as replacements for metallic materials in the application sectors of rail vehicles, the construction of buildings and air travel.

Unsaturated polyester resins (UP resins), epoxy resins (EP resins) and polyurethanes (PU resins) are combustible and therefore need flame retardants in some applications. Increasing demands in the market for fire protection and for environmental compatibility in products are increasing interest in halogen-free flame retardants, for example in phosphorus compounds or metal hydroxides.

Depending on the application sector, there are different requirements in relation to mechanical, electrical and fire-protection properties. In the rail vehicle sector in particular, fire-protection requirements have recently been made more stringent.

It is known that bromine- or chlorine-containing acid and/or alcohol components are used to formulate flame-retardant unsaturated polyester resins. Examples of these components are hexachloroendomethylene tetrahydrophthalic acid (HET acid), tetrabromophthalic acid and dibromoneopentyl glycol. Antimony trioxide is often used as a synergist.

In JP-05 245 838 (CA 1993: 672700), aluminum hydroxide, red phosphorus and antimony trioxide are combined with a brominated resin to improve flame retardancy. A disadvantage of bromine- and chlorine-containing resins is that corrosive gases are produced in a fire, and this can result in considerable damage to electronic components, for example to relays in rail vehicles. Unfavorable conditions can also lead to the formation of polychlorinated or brominated dibenzodioxins and furans. There is therefore a requirement for unsaturated polyester resins and unsaturated polyester molding compositions which are flame-retardant and halogen-free.

It is known that unsaturated polyester resins and unsaturated polyester molding compositions may be provided with fillers, such as aluminum hydroxide. The elimination of water from aluminum hydroxide at elevated temperatures gives some degree of flame retardancy. At filler levels of from 150 to 200 parts of aluminum hydroxide per 100 parts of UP resin it is possible to achieve self-extinguishing properties and low smoke density. A disadvantage of systems of this type is their high specific gravity, and attempts are made to reduce this by adding, for example, hollow glass beads [Staufer, G., Sperl, M., Begemann, M., Buhl, D., Düll-Mühlbach, I., Kunststoffe 85 (1995), 4].

PL 159 350 (CA 1995: 240054) describes laminates made from unsaturated polyester resins with up to 180 parts of magnesium hydroxide. However, injection processes, which are extremely important industrially, cannot be used with formulations of this type, due to the high viscosity of the uncured UP resin with the aluminum hydroxide or, respectively, magnesium hydroxide.

The processes described at a later stage below for formulating flame-retardant unsaturated polyester resins likewise have a large number of disadvantages, in particular the requirement for a very high filler content.

To reduce the total filler content, aluminum hydroxide can be combined with ammonium polyphosphate, as described in DE-A-37 28 629. JP 57016017 (CA96(22): 182248) describes the use of red phosphorus as a flame retardant for unsaturated polyester resins, and JP-55 094 918 (CA93(24): 22152t) describes the combination of aluminum hydroxide, red phosphorus and antimony trioxide.

PL 161 333 (CA 1994: 632278) achieves low smoke density and low-toxicity decomposition products by using aluminum hydroxide, magnesium hydroxide or basic magnesium carbonate, red phosphorus and, if desired, finely dispersed silica. DE-A-21 59 757 moreover claims the use of melamine and aluminum hydroxide.

Since aluminum hydroxide on its own is not a very effective flame retardant for unsaturated polyester resins or for epoxy resins, combinations with red phosphorus are also proposed, in order to reduce the filler content. A disadvantage here, however, is the red intrinsic color of the product, limiting its use to components with dark pigmentation.

Unsaturated polyester resins are solutions, in copolymerizable monomers, preferably styrene or methyl methacrylate, of polycondensation products made from saturated and unsaturated dicarboxylic acids, or from anhydrides of these, together with diols. UP resins are cured by free-radical polymerization using initiators (e.g. peroxides) and accelerators. The double bonds in the polyester chain react with the double bond in the copolymerizable solvent monomer. The most important dicarboxylic acids for preparing the polyesters are maleic anhydride, fumaric acid and terephthalic acid. The diol most frequently used is 1,2-propanediol. Use is also made of ethylene glycol, diethylene glycol and neopentyl glycol, inter alia. The most suitable crosslinking monomer is styrene. Styrene is fully miscible with the resins and copolymerizes readily. The styrene content in unsaturated polyester resins is normally from 25 to 40%. A monomer which can be used instead of styrene is methyl methacrylate.

Unsaturated polyester resins differ in their chemical and physical properties and in their fire behavior significantly from the similarly named polyesters, which, however, in contrast to the aforementioned unsaturated polyester resins, are thermoplastic polymers. These polyesters are also prepared by completely different processes than those as described in the preceding paragraph for the unsaturated polyester resins. Polyesters can be prepared, for example, by ring-opening polymerization of lactones or by polycondensation of hydroxycarboxylic acids, in which case polymers of the general formula —[O—R—(CO)]— are obtained. The polycondensation of diols and dicarboxylic acids and/or derivatives of dicarboxylic acids produces polymers of the general formula —[O—R¹—O—(CO)—R²—(CO)]—. Branched and crosslinked polyesters can be obtained by polycondensation of alcohols having a functionality of three or more with polyfunctional carboxylic acids.

Unsaturated polyester resins and polyesters are therefore two completely different polymers and represent completely different polymer groups.

Another group of thermosets, epoxy resins, are nowadays used for preparing molding compositions and coatings with a high level of thermal, mechanical and electronic properties.

Epoxy resins are compounds prepared by a polyaddition reaction of an epoxy resin component with a crosslinking (hardener) component. The epoxy resin components used are aromatic polyglycidyl esters, such as bisphenol A diglycidyl ester, bisphenol F diglycidyl ester or polyglycidyl esters of phenol-formaldehyde resins or cresol-formaldehyde resins, or polyglycidyl esters of phthalic, isophthalic or terephthalic acid, or else of trimellitic acid, N-glycidyl compounds of aromatic amines or of heterocyclic nitrogen bases, or else di- or polyglycidyl compounds of polyhydric aliphatic alcohols. Hardeners which are used are polyamines, such as triethylene tetramine, aminoethylpiperazine or isophoronediamine, polyamidoamines, polybasic acids or anhydrides of these, e.g. phthalic anhydride, hexahydrophthalic anhydride or methyltetrahydrophthalic anhydride, or phenols. The crosslinking may also take place via polymerization using suitable catalysts.

Epoxy resins are suitable for the potting of electrical or electronic components, and for saturation and impregnation processes. The epoxy resins used in electrical engineering are predominantly flame-retardant and used for printed circuit boards or insulators.

In the prior art, epoxy resins for printed circuit boards are currently rendered flame-retardant by including bromine-containing aromatic compounds in the reaction, in particular tetrabromobisphenol A. A disadvantage is that brominated hydrocarbon (a dangerous substance) is liberated in a fire, and this can cause corrosion damage. Under unfavorable conditions, polybrominated dibenzodioxins and furans can also be produced. The use of aluminum hydroxide is completely excluded since it eliminates water when processed.

Fire-protection requirements for electrical and electronic equipment are laid down in specifications and standards for product safety. In the US, fire-protection testing and approval procedures are carried out by Underwriters Laboratories (UL), and UL specifications are nowadays accepted worldwide. The fire tests for plastics were developed in order to determine the resistance of the materials to ignition and flame spread.

The materials have to pass horizontal burning tests (Classification UL 94HB) or the more stringent vertical tests (UL 94V-2, V-1 or V-0), depending on the fire-protection requirements. These tests simulate low-energy ignition sources which occur in electrical devices and to which plastic parts in electrical modules can be exposed.

Surprisingly, it has now been found that salts of phosphinic acids, even with the addition of small amounts of inorganic or mineral compounds which do not contain nitrogen, prove to be effective flame retardants for thermoset resins, such as unsaturated polyester resins or epoxy resins.

In addition it has been found that the stated additions can also improve the flame retardancy effect of phosphinates in combination with nitrogen-containing or phosphorus-nitrogen-containing synergists.

Alkali metal salts of phosphinic acids have previously been proposed as flame-retardant additives for thermoplastic polyesters (DE-A-44 30 932). They have to be added in amounts of up to 30% by weight. The salts of phosphinic acids with an alkali metal or with a metal of the second or third main group of the Periodic Table, in particular the zinc salts (DE-A-2 447 727) have also been used to prepare flame-retardant polyamide molding compositions. There is a marked difference in fire performance between thermoplastic polyesters, such as PET and PBT, and thermosetting polyesters, such as unsaturated polyester resins: in a fire thermoplastic materials produce drops of falling material, but thermosetting materials do not melt or produce drops of falling material.

Specifically, the invention relates to flame-retardant thermoset compositions which comprise, as flame retardant, at least one phosphinic salt of the formula (I) and/or a diphosphinic salt of the formula (II) and/or polymers of these (component A) 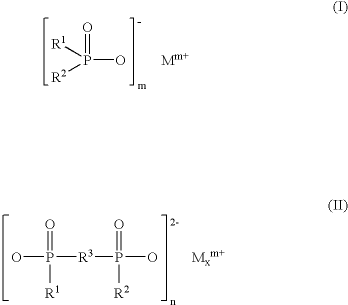
where
R¹,R² are identical or different and are C₁-C₆-alkyl, linear or branched, and/or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K and/or a protonated nitrogen base;
m is from 1 to 4;
n is from 1 to 4; and
x is from 1 to 4,
   and also comprise as component B at least one synthetic inorganic compound and/or a mineral product.

M is preferably calcium, aluminum or zinc.

Protonated nitrogen bases are preferably the protonated bases of ammonia, melamine, triethanolamine, in particular NH₄⁺.

R¹ and R² are preferably identical or different and are C₁-C₆-alkyl, linear or branched, and/or phenyl.

R¹ and R² are preferably identical or different and are methyl, ethyl, n-propyl, isopropyl, n-butyl, tert-butyl, n-pentyl and/or phenyl.

R³ is preferably methylene, ethylene, n-propylene, isopropylene, n-butylene, tert-butylene, n-pentylene, n-octylene or n-dodecylene.

Other preferred radicals for R³ are phenylene and naphthylene.

Other preferred radicals for R³ are methylphenylene, ethylphenylene, tert-butylphenylene, methylnaphthylene, ethylnaphthylene and tert-butylnaphthylene.

Other preferred radicals for R³ are phenylmethylene, phenylethylene, phenylpropylene and phenylbutylene.

The novel flame-retardant thermoset compositions preferably comprise from 0.1 to 30 parts by weight of at least one phosphinic salt of the formula (I) and/or a diphosphinic salt of the formula (II) and/or polymers of these (component A), and from 0.1 to 100 parts by weight of component B, per 100 parts by weight of thermoset composition.

The novel flame-retardant thermoset compositions particularly preferably comprise from 1 to 15 parts by weight of at least one phosphinic salt of the formula (I) and/or a diphosphinic salt of the formula (II) and/or polymers of these (component A), and from 1 to 20 parts by weight of component B, per 100 parts by weight of thermoset composition.

Component B is preferably an oxygen compound of silicon, or comprises magnesium compounds, metal carbonates of metals from main group two of the periodic table, red phosphorus, zinc compounds or aluminum compounds.

The oxygen compounds of silicon are preferably salts and esters of orthosilicic acid and the condensation products thereof, silicates, zeolites and silicas, or glass, glass-ceramic or ceramic powders.

The magnesium compounds are preferably magnesium hydroxide, hydrotalcites, magensium carbonates or magnesium calcium carbonates.

The red phosphorus is preferably elemental red phosphorus or formulations in which the phosphorus has been surface-coated with liquid substances of low molecular mass such as silicone oil, liquid paraffin or esters of phthalic acid or adipic acid or with polymeric or oligomeric compounds, e.g., with phenolic resins or amino resins and also polyurethanes.

The zinc compounds are preferably zinc oxide, zinc stannate, zinc hydroxystannate, zinc phosphate, zinc borate or zinc sulfides.

The aluminum compounds are preferably aluminum hydroxide or aluminum phosphate.

Component B, already mentioned earlier on above, is a synthetic inorganic compound and/or a mineral product from the following groups:

Preference is also given to oxygen compounds of silicon, such as salts and esters of orthosilicic acid and the condensation products thereof (silicates). An overview of appropriate silicates is given, for example, in Riedel, Anorganische Chemie, 2nd ed., pp. 490-497, Walter de Gruyter, Berlin-N.Y. 1990. Of particular interest are phyllosilicates (sheet silicates, layered silicates) such as, for instance, talc, kaolinite and mica, and the group of the bentonites and montmorillonites, and also tectosilicates (framework silicates), such as the group of the zeolites, for example. In addition it is also possible to use silicon dioxide in the form of highly disperse silica.

The silica can have been produced by a pyrogenic process or by a wet-chemical process. The stated silicates and silicas can be equipped where appropriate with organic modifiers in order to achieve particular surface properties.

As synergistic component it is likewise possible to use glass, glass-ceramic and ceramic powders of various composition, as described, for example, in Ullmann's Encyclopedia of Industrial Chemistry, 5th edition, vol. A 12 (1989), pp. 372-387 (glass) and pp. 443-448 (glass-ceramic). Corresponding ceramic materials are described in vol. 6 (1986) on pp. 12-18 (Commercial Ceramic Clays). Both glasses and/or ceramics having defined melting point can be used, and also mixtures of products having a broad melting range, such as ceramic frits, as used to produce glazes. Such frits, or mixtures of two or more frits, may also further comprise glass fibers, basalt fibers or ceramic fibers. Mixtures of this kind are described in, for example, EP 0 287 293 B1.

As synergistic component it is likewise possible to use magnesium compounds, such as magnesium hydroxide, and also hydrotalcites of the general formula Mg₍₁₋ₐ₎Alₐ(OH)₂A_{a/2}pH₂O, where
A is the anions SO₄²⁻ or CO₃²⁻,
a is greater than 0 and less than/equal to 0.5, and
p is the number of water molecules in the hydrotalcite and has a value of between 0 and 1.

Hydrotalcites wherein A represents the anion CO₃²⁻ and 0.2≦a≦0.4 are preferred.

The hydrotalcites can be both natural hydrotalcites, which may be modified where appropriate by corresponding chemical treatment, or synthetic products.

As synergistic component it is likewise possible to use metal carbonates of metals from main group two of the periodic table, and mixtures thereof.

Suitability is possessed by magnesium calcium carbonates (b₁) of the general formula Mg_{b}Ca_{c}(CO₃)_{b+c}qH₂O, where
b and c are numbers from 1 to 5 and b/c≧1 and q≧0,
and also basic magnesium carbonates (b₂) of the general formula Mg_{d}(CO₃)ₑ(OH)_{2d-2e}rH₂O, where
d is a number from 1 to 6, e is a number greater than 0 and less than 6, and d/e>1 and r≧0.

Particular suitability is possessed by mixtures of b₁ and b₂, the quantitative ratio of b₁ to b₂ being in the range from 1:1 to 3:1.

The magnesium calcium carbonates b₁ and basic magnesium carbonates b₂ can be used in both hydrous and anhydrous form and with or without surface treatment. These types of compound include the naturally occurring minerals such as huntite (b₁) and hydromagnesite (b₂) and mixtures thereof.

As synergistic component it is likewise possible to use zinc compounds such as zinc oxide, zinc stannate, zinc hydrostannate, zinc phosphates and zinc sulfides, and also zinc borates of the general formula fZnOgB₂O₃hH₂O, where f, g and h denote values between 0 and 14.

The flame-retardant combination of the invention preferably comprises, as a further component, nitrogen compounds and/or phosphorus-nitrogen compounds.

The nitrogen compounds are preferably those of the formulae (III) to (VIII) or mixtures thereof 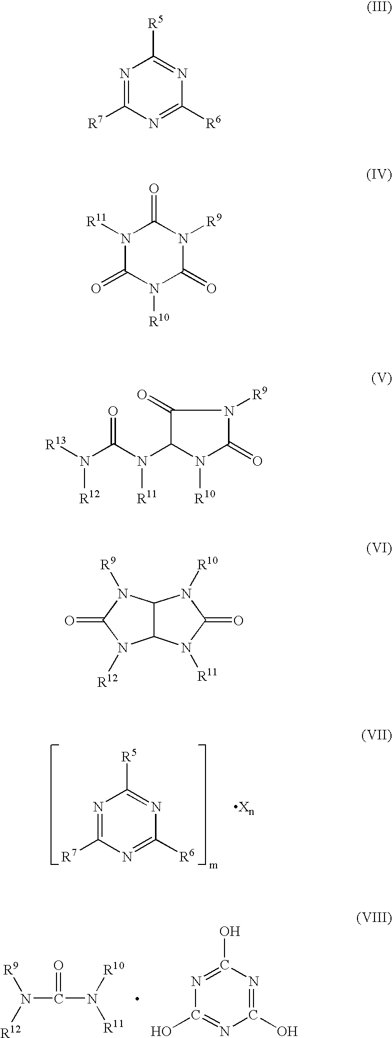
in which
R⁵ to R⁷ are hydrogen, C₁-C₈-alkyl, C₅-C₁₆-cycloalkyl or -alkylcycloalkyl,
   possibly substituted by a hydroxyl or a C₁-C₄-hydroxyalkyl function, C₂-C₈-alkenyl, C₁-C₈-alkoxy, -acyl, -acyloxy, C₆-C₁₂-aryl or -arylalkyl, —OR⁸ and
   —N(R⁸)R⁹, and also N-alicyclic or N-aromatic,
   R⁸ is hydrogen, C₁-C₈-alkyl, C₅-C₁₆-cycloalkyl or -alkylcycloalkyl, possibly substituted by a hydroxyl or a C₁-C₄-hydroxyalkyl function, C₂-C₈-alkenyl,
   C₁-C₈-alkoxy, -acyl, -acyloxy or C₆-C₁₂-aryl or -arylalkyl,
R⁹ to R¹³ are the same groups as R⁸ and also —O—R⁸,
m and n independently of one another are 1, 2, 3 or 4,
X denotes acids which are able to form adducts with triazine compounds (III);
   or are oligomeric esters of tris(hydroxyethyl)isocyanurate with aromatic polycarboxylic acids or are nitrogen-containing phosphates of the formulae (NH₄)_{y}H_{3-y}PO₄ and (NH₄PO₃)_{z}, with y being 1 to 3 and z being 1 to 10 000.

The nitrogen compound or the phosphorus-nitrogen compound is preferably melamine, melamine derivatives of cyanuric acid, melamine derivatives of isocyanuric acid, melamine salts such as melamine phosphate or melamine diphosphate, melamine polyphosphate, dicyandiamide, allantoin, glycoluril or a guanidine compound such as guanidine carbonate, guanidine phosphate, guanidine sulfate, benzoguanamine and/or condensation products of ethyleneurea and formaldehyde and/or comprises ammonium polyphosphate and/or comprises carbodiimides.

In addition to those mentioned above, the nitrogen component or phosphorus-nitrogen component used can comprise oligomeric esters of tris(hydroxyethyl)isocyanurate with aromatic polycarboxylic acids, as described in EP-A-584 567, and nitrogen-containing phosphates of the formulae (NH₄)_{y}H_{3-y}PO₄ and (NH₄PO₃)_{z}, where y can adopt numerical values from 1 to 3 and z is a number of any size (for instance from 1 to 10 000), typically also represented as the average value of a chain length distribution.

The flame-retardant thermoset compositions preferably comprise from 0.1 to 30 parts by weight of phosphinic salt of the formula (I) and/or a diphosphinic salt of the formula (II) and/or polymers of these (component A), and from 0.1 to 100 parts by weight of component B, and from 0.1 to 100 parts by weight of component C, per 100 parts by weight of thermoset composition.

The flame-retardant thermoset compositions particularly preferably comprise from 1 to 15 parts by weight of phosphinic salt of the formula (I) and/or a diphosphinic salt of the formula (II) and/or polymers of these (component A), and from 1 to 20 parts by weight of component B, and from 1 to 20 parts by weight of component C per 100 parts by weight of thermoset composition.

The invention further relates to flame-retardant thermoset compositions which are molding compositions, coatings or laminates made from thermoset resins.

The thermoset resins are preferably unsaturated polyester resins or epoxy resins.

The invention further relates to a process for preparing flame-retardant thermoset compositions, which comprises mixing a thermoset resin with a flame retardant made from at least one phosphinic salt of the formula (I) and/or a diphosphinic salt of the formula (II) and/or polymers of these (component A) with at least one component B selected from the group of substances above, and wet-pressing (cold-pressing) the resultant mixture at pressures of from 3 to 10 bar and at temperatures of from 20 to 80° C.

The invention further relates to a process for preparing flame-retardant thermoset compositions, which comprises mixing a thermoset resin with a flame retardant made from at least one phosphinic salt of the formula (I) and/or a diphosphinic salt of the formula (II) and/or polymers of these (component A) with at least one component B selected from the group of substances above, and wet-pressing (warm- or hot-pressing) the resultant mixture at pressures of from 3 to 10 bar and at temperatures of from 80 to 150° C.

Another process for preparing flame-retardant thermoset compositions according to the present invention comprises mixing a thermoset resin with a flame retardant made from at least one phosphinic salt of the formula (I) and/or a diphosphinic salt of the formula (II) and/or polymers of these (component A) with at least one component B selected from the group of substances above, and processing the resultant mixture at pressures of from 50 to 150 bar and at temperatures of from 140 to 160° C. to give prepregs.

Finally, the invention also relates to the use of the novel flame-retardant combination for rendering thermoset compositions flame-retardant.

The thermoset compositions are preferably unsaturated polyester resins or epoxy resins, and are preferably molding compositions, coatings or laminates.

The salts of the phosphinic acids, as used according to the invention, may be prepared by known methods as described in more detail, for example, in EP-A-0 699 708.

As set out in the examples below, it has been shown that when tested by themselves, even at relatively high concentrations in thermoset resins, the synergistic components, synthetic inorganic compounds and/or mineral products and/or nitrogen compounds and/or phosphorus-nitrogen compounds, and salts of phosphinic acids of the general formula (I) or (II) have little effect.

Surprisingly, it has now been found that a combination of phosphinic salts and synergistic component is suitable for achieving the best material classification, V-0, in the UL 94 vertical test in thermosets. The compounds used in the examples are as follows:
®Alpolit SUP 403 BMT (Vianova Resins GmbH, Wiesbaden, Germany): unsaturated polyester resin, about 57% strength in styrene, acid number not more than 30 mg KOH/g, preaccelerated and formulated to be slightly thixotropic, low viscosity (viscosity from a 4 mm flow cup: 110 ±10 s) and greatly reduced styrene emission.
®Palatal 340 S (DSM-BASF Structural Resins, Ludwigshafen, Germany): unsaturated polyester resin, about 49% strength in styrene and methyl methacrylate, density 1.08 g/ml, acid number 7 mg KOH/g, preaccelerated, low viscosity (dynamic viscosity about 50 mPa*s).
®Beckopox EP 140 (Vianova Resins GmbH, Wiesbaden, Germany): low-molecular-weight condensation product from bisphenol A and epichlorohydrin with a density of 1.16 g/ml and an epoxy equivalent of from 180 to 192.
®Beckopox EH 625 (Vianova Resins GmbH, Wiesbaden, Germany): modified aliphatic polyamine with an active hydrogen equivalent weight of 73 and a dynamic viscosity of about 1000 mPa*s.
®Modar 835 S (Ashland Composite Polymers Ltd., Kidderminster, England): modified acrylate resin dissolved in styrene, viscosity about 55 mPa*s at 25° C.
®Martinal ON 921 (Martinswerk GmbH, Bergheim, Germany): low-viscosity increase flame-retardant aluminum hydroxide filler for plastic resins, with particle size of >60%<45 μm.
®Exolit AP 422 (Clariant GmbH, Frankfurt am Main, Germany): finely divided, low-water-solubility ammonium polyphosphate of formula (NH₄PO₃)ₙ, where n=approx. 700, with particle size of >99%<45 μm.
Cobalt accelerator NL 49P (Akzo Chemie GmbH, Düren, Germany): cobalt octoate solution in dibutyl phthalate with a cobalt content of 1% by weight.
Cobalt accelerator NL 63-10S (Akzo Chemie GmbH, Düren, Germany).
Butanox M 50 (Akzo Chemie GmbH, Düren, Germany): methyl ethyl ketone peroxide phlegmatized with dimethyl phthalate—clear liquid with a content of at least 9% by weight of active oxygen.
Lucidol BT 50 dibenzoyl peroxide (Akzo Chemie GmbH, Düren, Germany).
DEPAL: aluminum salt of diethylphosphinic acid.
Aluminum phosphate, Riedel de Haen, D
DHT-4A (dihydrotalcite), Kyowa Chemical Industry, J
DHT Exm 697-2 (dihydrotalcite), Sud-Chemie AG, D
Exolit® RP 605 (red phosphorus), Clariant GmbH, D
Firebrake® ZB (zinc borate), US Borax & Chemical Corporation, USA
Martinal OL 104 (aluminum hydroxide), Martinswerke, D
Securoc® C 10N (huntite/hydromagnesite), Incemin AG, CH
Zinc oxide, Merck, D
Zinc stannate, Storey+Co., UK
Melamine grade 003 (melamine), DSM, NL
Melapur® MC (melamine cyanurate), DSM Melapur, NL
Melapur® MP (melamine phosphate), DSM Melapur, NL
   Preparation of Test Specimens

The thermoset resin and the flame retardant components, and also, if desired, other additives are mixed homogeneously using a dissolver disk. Homogenization is repeated after adding the curing agent.

In the case of unsaturated polyester resins, the resin is mixed with the cobalt accelerator, the flame retardant components are added and the curing is initiated by adding the peroxide after homogenization.

In the case of epoxy resins, the flame retardant components are added to the epoxy resin component and mixed homogeneously. The amine hardener or, respectively, the anhydride hardener is then added.

Two layers of continuous-strand glass-fiber mat of 450 g/m² weight per unit area, on a ®Hostaphan release film and a steel frame, are placed in a heated press. About half of the resin-flame-retardant mixture is then uniformly distributed. Another glass mat is then added and then the remaining resin-flame-retardant mixture is distributed, the laminate is covered with a release film and a pressed sheet of 4 mm thickness is produced at a temperature of 50° C. during a period of one hour at a pressure of 10 bar.

The fire performance testing was carried out according to the Underwriters Laboratories “Test for Flammability of Plastics Materials—UL 94” specification, in the May 2, 1975 edition, using specimens of length 127 mm, width 12.7 mm and various thicknesses.

The determination of oxygen index was based on ASTM D 2863-74, using a modified apparatus.

1. Results With Unsaturated Polyester Resins

Table 1 shows comparative examples with use, on their own, of aluminum hydroxide, melamine, ammonium polyphosphate and DEPAL as flame retardants for an unsaturated polyester resin (Viapal UP 403 BMT). It can be seen from the table that the use, on its own, of aluminum hydroxide at concentrations up to 175 parts per 100 parts of unsaturated polyester resin cannot achieve V-0 classification.

Nor can the use, on their own, of melamine or ammonium polyphosphate at concentrations of up to 75 parts per 100 parts of unsaturated polyester resin achieve V-0 classification.

Table 1 (Comparative Examples):

Fire performance of unsaturated polyester resin laminates to UL 94, 30% by weight of continuous-strand glass-fiber mat, laminate thickness 1.5 mm, Viapal UP 403 BMT resin, Butanox M50 hardener, NL 49 P accelerator.

| | Parts of flame | | |
|---|---|---|---|
| | retardant/100 parts | UL 94 | |
| Example No. | resin | classification | LOI |
| 1 | 125 ATH* | n.c. | 0.30 |
| 2 | 175 ATH | n.c. | 0.37 |
| 3 | 25 Exolit AP 422 | n.c. | 0.23 |
| 4 | 75 Exolit AP 422 | n.c. | 0.26 |
| 5 | 25 melamine | n.c. | 0.23 |
| 6 | 75 melamine | n.c. | 0.33 |
| 7 | 25 DEPAL** | n.c. | 0.33 |
| 8 | 100 chalk | n.c. | 0.27 |
| 9 | 10 zinc borate | n.c. | — |
| 10 | 10 zinc stannate | n.c. | — |
| 11 | 10 zinc oxide | n.c. | — |
| 12 | ***RP 614*** | n.c. | 0.27 |

*ATH = alumina trihydrate (Martinal ON 921)
**DEPAL = aluminum salt of diethylphosphinic acid
***RP 614 = red P as a dispersion
n.c. = not classifiable under the UL 94 vertical test

Table 2 shows the novel combination of DEPAL with the synergistic components in the unsaturated polyester resin Viapal UP 403 BMT. Here, a V-0 classification can be achieved with a laminate thickness of 1.5 mm by combining DEPAL with the synergistic components. The laminates may be pigmented as desired.

The low filler content of these UP resin laminates meant that they could be used in injection processes.

Table 2 (Invention):

Fire performance of unsaturated polyester resin laminates to UL 94, 30% by weight of continuous-strand glass-fiber mat, laminate thickness 1.5 mm, Viapal UP 403 BMT resin, Butanox M50 hardener, NL 49 P accelerator.

| | Parts of flame | | |
|---|---|---|---|
| | retardant/100 parts | UL 94 | |
| Example No. | resin | classification | LOI |
| 1 | 10 DEPAL + 10 zinc borate | V-0 | 0.40 |
| 2 | 10 DEPAL + 10 zinc oxide | V-0 | 0.41 |
| 3 | 10 DEPAL + 15 RP 614 | V-0 | 0.43 |

2. Results with Epoxy Resins

Table 3 shows fire tests using a polyamine-cured epoxy resin (Beckopox EP 140 resin, Beckopox EH 625 hardener). By combining DEPAL with synergistic components, V-0 classification is achieved at a laminate thickness of 1.5 mm. In contrast, UL 94 V-0 is not achieved using the components on their own.

Table 3:

Fire performance of epoxy resin moldings to UL 94, material thickness 1.6 mm, resin 100 parts of Beckopox EP 140, hardener 39 parts of Beckopox EH 625.

| | Parts flame retardant/ | UL 94 | |
|---|---|---|---|
| Example No. | 100 parts resin | classification | LOI |
| 1 | 10 DEPAL | n.c | 0.27 |
| 2 | 20 DEPAL | V-1 | 0.32 |
| 3 | 20 zinc borate | n.c. | 0.23 |
| 4 | 20 zinc stannate | n.c. | 0.25 |
| 5 | 20 zinc oxide | n.c. | 0.25 |
| 6 | 10 DEPAL + 10 zinc borate | V-0 | 0.39 |
| 7 (inv.) | 10 DEPAL + 10 zinc oxide | V-0 | 0.38 |
| 8 (inv.) | 10 DEPAL + 10 zinc stannate | V-0 | 0.41 |

1. A flame-retardant thermoset composition which comprise a flame retardant, selected from the group consisting of phosphinic salt of the formula (I) a diphosphinic salt of the formula (II) polymer of the phosphinic salt of formula (I), a polymer of the diphosphinic salt of formula (II) and mixtures thereof (component A) 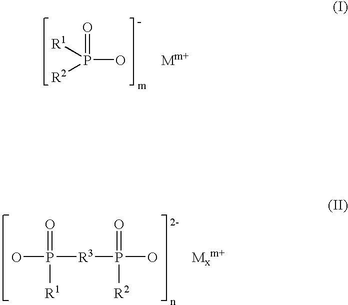
where
R¹,R² are identical or different and are C₁-C₆-alkyl, linear or branched, or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K or a protonated nitrogen base;
m is from 1 to 4;
n is from 1 to 4; and
x is from 1 to 4,
and as component B a compound selected from the group consisting of a synthetic inorganic compound, a mineral product and mixtures thereof.

2. A flame-retardant thermoset composition as claimed in claim 1, wherein R¹ and R² are identical or different and are C₁-C₆-alkyl, linear or branched, or phenyl.

3. A flame-retardant thermoset composition as claimed in claim 1, wherein R¹ and R² are identical or different and are methyl, ethyl, n-propyl, isopropyl, n-butyl, tert-butyl, n-pentyl or phenyl.

4. A flame-retardant thermoset composition as claimed claim 1, wherein R³ is methylene, ethylene, n-propylene, isopropylene, n-butylene, tert-butylene, n-pentylene, n-octylene or n-dodecylene.

5. A flame-retardant thermoset composition as claimed in claim 1, wherein R³ is phenylene or naphthylene.

6. A flame-retardant thermoset composition as claimed in claim 1, wherein R³ is methylphenylene, ethylphenylene, tert-butylphenylene, methylnaphthylene, ethylnaphthylene or tert-butylnaphthylene.

7. A flame-retardant thermoset composition as claimed in claim 1, wherein R³ is phenylmethylene, phenylethylene, phenylpropylene or phenylbutylene.

8. A flame-retardant thermoset composition as claimed in claim 1, comprising from 0.1 to 30 parts by weight of component A, and from 0.1 to 100 parts by weight of component B, per 100 parts by weight of the thermoset composition.

9. A flame-retardant thermoset composition as claimed in claim 1, comprising from 1 to 15 parts by weight of component A, and from 1 to 20 parts by weight of component B, per 100 parts by weight of the thermoset composition.

10. A flame-retardant thermoset composition as claimed in claim 1, wherein component B is selected from the group consisting of an oxygen compound of silicon, magnesium compounds, metal carbonates of metals from main group two of the periodic table, red phosphorus, zinc compounds and aluminum compounds.

11. A flame-retardant thermoset composition as claimed in claim 1, wherein component B is selected from the group consisting of oxygen compounds of silicon, salts and esters of orthosilicic acid and the condensation products thereof, silicates, zeolites, silicas, glass, glass-ceramic, ceramic powders.

12. A flame-retardant thermoset composition as claimed in claim 1, further comprising as component C a compound selected from the group consisting of nitrogen compounds, phosphorus-nitrogen compounds, and mixtures thereof.

13. A flame-retardant thermoset composition as claimed in claim 12, comprising from 0.1 to 30 parts by weight of component A, from 0.1 to 100 parts by weight of component B, and from 0.1 to 100 parts by weight of component C, per 100 parts by weight of the thermoset composition.

14. A flame-retardant thermoset composition as claimed in claim 12, comprising from 1 to 15 parts by weight of component A from 1 to 20 parts by weight of component B, and from 1 to 20 parts by weight of component C, per 100 parts by weight of the thermoset composition.

15. A flame-retardant thermoset composition as claimed in claim 12, wherein component C is selected from the group consisting of melamine, a melamine derivative of cyanuric acid, a melamine derivative of isocyanuric acid, a melamine salt, melamine polyphosphate, melamine diphosphate, and melamine dicyandiamide a guanidine compound a condensation product of ethyleneurea and formaldehyde and a carbodiimide.

16. A flame-retardant thermoset composition as claimed in claim 1, wherein the thermoset composition is selected from the group consisting of a molding composition, a coating or a laminate made from thermoset resins.

17. A flame-retardant thermoset composition as claimed in claim 16, wherein the thermoset resins are unsaturated polyester resins or epoxy resins.

18. A process for preparing flame-retardant thermoset compositions as claimed in claim 1 comprising the steps of mixing a thermoset resin with component A, and at least one component B to form a mixture, and wet-pressing the mixture at a pressure of from 3 to 10 bar and at a temperature of from 20 to 60° C.

19. A process for preparing flame-retardant thermoset compositions as claimed in claim 1, comprising the steps of mixing a thermoset resin with component A, and at least one component B to form a mixture, and wet-pressing the mixture at a pressure of from 3 to 10 bar and at a temperature of from 80 to 150° C.

20. A process for preparing flame-retardant thermoset compositions as claimed in claim 1 comprising the steps of mixing a thermoset resin with component A, and at least one component B to form a mixture, and processing the mixture at a pressure of from 50 to 150 bar and at a temperature of from 140 to 160° C. to give prepregs.

21. A flame-retardant thermoset composition as claimed in claim 1, wherein component B is selected from the group of magnesium compounds, zinc compounds and aluminum compounds.

22. A flame-retardant thermoset composition as claimed in claim 21, wherein the magnesium compounds are selected from the group consisting of magnesium hydroxide, magnesium hydrotalcites, magnesium carbonates and magnesium calcium carbonates.

23. A flame-retardant thermoset composition as claimed in claim 21, wherein the zinc compounds are selected from the group consisting of zinc oxide, zinc stannate, zinc hydroxystannate, zinc phosphate, zinc borate and zinc sulfides.

24. A flame-retardant thermoset composition as claimed in claim 21, wherein the aluminum compounds are selected from the group consisting of aluminum hydroxide and aluminum phosphate.

25. A flame-retardant thermoset composition as claimed in claim 15, wherein the melamine salt is melamine phosphate.

26. A flame-retardant composition as claimed in claim 12, wherein the guanidine compound is selected from the group consisting of guanidine carbonate, guanidine phosphate and guanidine sulfate.

27. The process as claimed in claim 18, wherein the wet-pressing step further comprises cold pressing.

28. The process as claimed in claim 19, wherein the wet pressing step further comprises warm or hot pressing.
